(19) United States
(12) Patent Application Publication
(10) Pub. No.: US 2010/0315218 A1
(43) Pub. Date: Dec. 16, 2010

(54) Inclement Condition Speedometer

(76) Inventors: David Cades, Vienna, VA (US); Jane Barrow, Fairfax, VA (US); David Kidd, Oakton, VA (US); Erik Nelson, Annandale, VA (US); Daniel Roberts, Fairfax, VA (US)

Correspondence Address: GEORGE MASON UNIVERSITY;OFFICE OF TECHNOLOGY TRANSFER, MSN 5G5, 4400 UNIVERSITY DRIVE, FAIRFAX, VA, 22030, US

(21) Appl. No.: 12/758,273

(22) Filed: Apr. 12, 2010

Related U.S. Application Data
(60) Provisional application No. 61/186,527, filed on Jun. 12, 2009.

(51) Int. Cl. B60Q 1/00

(52) U.S. Cl. 340/441

(57) ABSTRACT

A system for communicating to a motor vehicle operator the maximum safe speed at which the vehicle can be operated. The system includes receiver(s), sensor(s), processor(s) and dashboard display(s). The receiver(s) detects a legal speed limit. Sensor(s) detects environmental conditions surrounding the motor vehicle. The processor(s): receive data from the receiver(s) and sensor(s); calculates a maximum safe speed; and calculates a safe speed range based on the maximum safe speed and the legal speed limit. The dashboard display alerts the driver if the maximum safe speed is less than the legal speed limit, and displays the safe speed range if the maximum safe speed is less than the legal speed limit.

### CROSS-REFERENCE TO RELATED APPLICATIONS

This application claims the benefit of U.S. Provisional Application No. 61/186,527, filed Jun. 12, 2009, the contents of which are hereby incorporated by reference.

### BRIEF DESCRIPTION OF THE SEVERAL VIEWS OF THE DRAWINGS

FIGS. 1A and 1B show a schematic diagram of a system for informing a motor vehicle operator of inclement conditions.

FIG. 2 illustrates a speedometer and speedometer display incorporating features according to aspects of an embodiment of the present invention.

FIGS. 3 and 4 illustrate a safe speed indicator incorporating features according to aspects of an embodiment of the present invention.

FIGS. 5A and 5B are flowcharts depicting the operations of a system according to aspects of an embodiment of the present invention.

FIG. 6 is an algorithm incorporating features according to aspects of an embodiment of the present invention.

### DETAILED DESCRIPTION OF EMBODIMENTS

Embodiments of the present invention relate to a system for informing a motor vehicle operator of inclement conditions, and more particularly, a system that monitors the legal speed limit and driving conditions, and notifies the operator when it is not safe to drive at or above the legal speed limit.

“GPS Receiver” means a device configured to receive Global Positioning System (“GPS”) signals for purposes of determining the type of road on which the motor vehicle is being operated, the legal speed limit, and other infrastructure information.

“Optical sensor” means a sensor configured to use light to determine the surface type of the road on which the motor vehicle is being operated, the legal speed limit or other infrastructure information, and/or conditions on the surface of the road. Optical road sensors may be directed towards the road surface and may determine whether the pavement is wet or has standing water, ice, or snow on it. These sensors may be mounted on various parts of a vehicle such as the front of the vehicle. Examples of several variations of this type of sensor are disclosed in U.S. Pat. Nos. 7,265,846, 6,049,387, and 6069565.

“Pattern recognition sensor” means a sensor configured to determine the type of road on which the motor vehicle is being operated, the legal speed limit, and/or other infrastructure information.

“Precipitation sensor” means a sensor configured to determine whether there is precipitation in the current location of the motor vehicle. An example of a precipitation sensor is a rain sensor or snow sensor. Rain and snow sensors may determine the amount of precipitation that has built up on a windshield. This information may be used to determine the degree of reduction in visibility due to weather conditions. Examples of rain sensors are disclosed in German Patent No 197 01 258 and U.S. Pat. No. 6,842,271.

“Temperature sensor” means a thermometer, thermocouple, or other device configured to determine the temperature in the current location of the motor vehicle.

“Traction sensor” means a sensor configured to determine the traction between one or more tires of the motor vehicle and the road and/or the coefficient of friction between the tires and the road. Traction sensors may be a good supplement to the optical road sensors as the optical sensors may become dirty. Currently, these type of sensors are integrated into vehicles to activate traction control systems when traction at one wheel decreases. However, newer versions of traction sensors that are configured to continuously measure the coefficient of friction between the wheel and the road, examples of which are disclosed in U.S. Pat. Nos. 6,525,671 and 6,928,857.

GPS Receiver: The GPS receiver will be used to determine the current road type, speed limit, and other infrastructure information. These systems are available from nearly every automotive manufacturer and are also available through many aftermarket companies as well. The above information is constantly updated by companies such as NAVTEQ (http://www.navteq [DOT] com/) who create richly detailed road maps for several GPS systems and mapping websites. The SLIC system will need to incorporate the legal speed limit into calculations as a point of reference for optimal conditions. Additionally, it is imperative that the SLIC system does not recommend a speed that is faster than the legal speed limit, which could occur if the system was not aware of lowered speed limits in special areas (e.g. construction zones, school zones).

Pattern Recognition: Pattern recognition can be used to determine the legal speed limit when the GPS system is unable to provide or incorrectly provides said information. GPS systems are unable to account for variable speed limits or specially lowered speed limits (e.g. construction zones); this optical sensor, however, can. Any time that there is a discrepancy between the GPS data and the pattern recognition data, the SLIC system will utilize the pattern recognition data in its calculations. This type of sensor is already being used for a similar application: the BMW 7-Series uses this sensor to inform its drivers of the current speed limit (http://www.bmw [DOT] com).

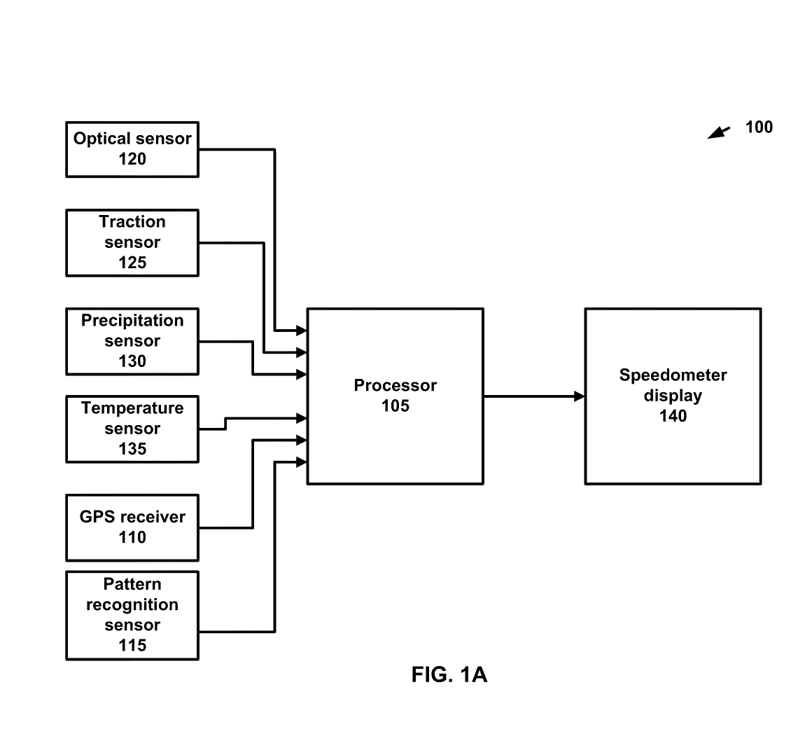

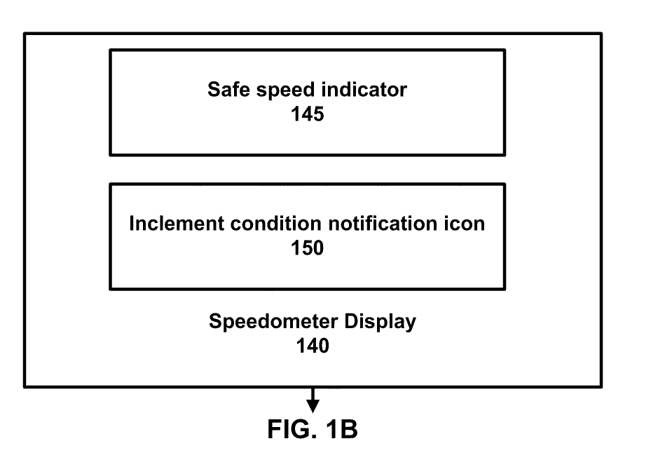

Embodiments of the present invention are described with reference to the attached drawings. FIGS. 1A and 1B are schematic diagrams showing an example configuration of a system 100 for communicating to a motor vehicle operator the maximum safe speed at which the vehicle may be operated. As shown in this example, this function may be performed by a processor 105 coupled with a GPS receiver 110, a pattern recognition sensor 115, an optical sensor 120, a traction sensor 125, a precipitation sensor 130 and a temperature sensor 135. Either a GPS receiver 110 or a pattern recognition sensor 115, or both, may be used, along with one or more of the optical sensor 120, traction sensor 125, precipitation sensor 130, or temperature sensor 135, or other vehicle/environment sensor. The processor 105 may also be coupled with a speedometer display 140, which may comprise a safe speed indicator 145 and an inclement condition notification icon 150. The inclement condition notification icon 150 may be configured and arranged to alert the driver that inclement conditions are present; to alert the driver that the maximum safe speed is less than the legal speed limit; and/or to alert the driver to reduce his speed.

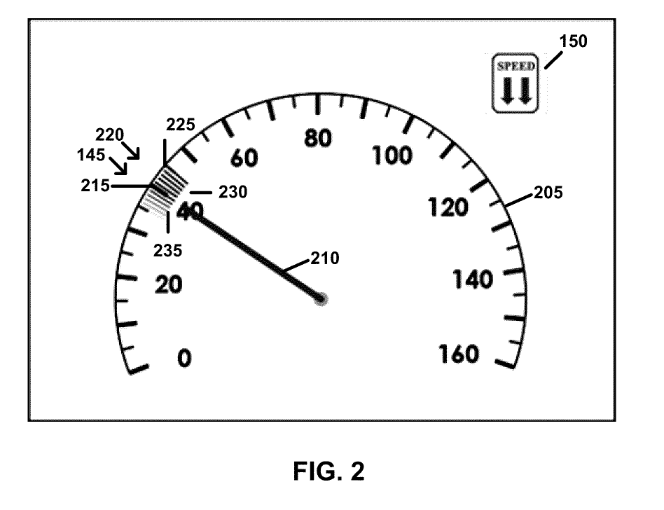

FIG. 2 illustrates an example speedometer display 140 coupled with a speedometer 205. The inclement condition notification icon 150 and safe speed indicator 145, as shown in FIG. 2, have both been triggered. The safe speed indicator 145 may be aligned with the speedometer 205, and the inclement condition notification icon 150 may be located near the speedometer 205. In FIG. 2, the needle 210 is pointing toward the maximum safe speed 215. Solid bars can be used to represent the safe speed range 220. The bars representing the range of speeds 230 above the maximum safe speed 215 may be one color, while the bars representing the range of speeds 235 equal to and less than the maximum safe speed 215 may be a second color. Red bars may be used to represent the range of speeds 230 above the maximum safe speed 215 and yellow bars may be used to represent the range of speeds 235 equal to and less than the maximum safe speed 215.

In FIG. 2, the saturation of the bars representing the range of speeds 235 equal to and less than the maximum safe speed 215 increases as the speed approaches the maximum safe speed 215. The bars representing the range of speeds 235 equal to and less than the maximum safe speed 215 may vary in saturation. The bars representing the range of speeds 235 equal to and less than the maximum safe speed 215 may have the same saturation. The extent of the range of speeds 235 equal to and less than the maximum safe speed 215 may vary. The safe speed indicator 145 shown in the example in FIG. 2 corresponds to six bars within the range of speeds 235 equal to and less than the maximum safe speed 215, varying from 35 miles per hour to 40 miles per hour. Any number of bars extending over any range can comprise the range of speeds 235 equal to and less than the maximum safe speed 215. The extent of the range of speeds 230 above the maximum safe speed 215 may also vary. The safe speed indicator 145 shown in FIG. 2 corresponds to five bars within the range of speeds 230 above the maximum safe speed 215, varying from 41 miles per hour to 45 miles per hour. Any number of bars extending over any range can comprise the range of speeds 230 above the maximum safe speed 215.

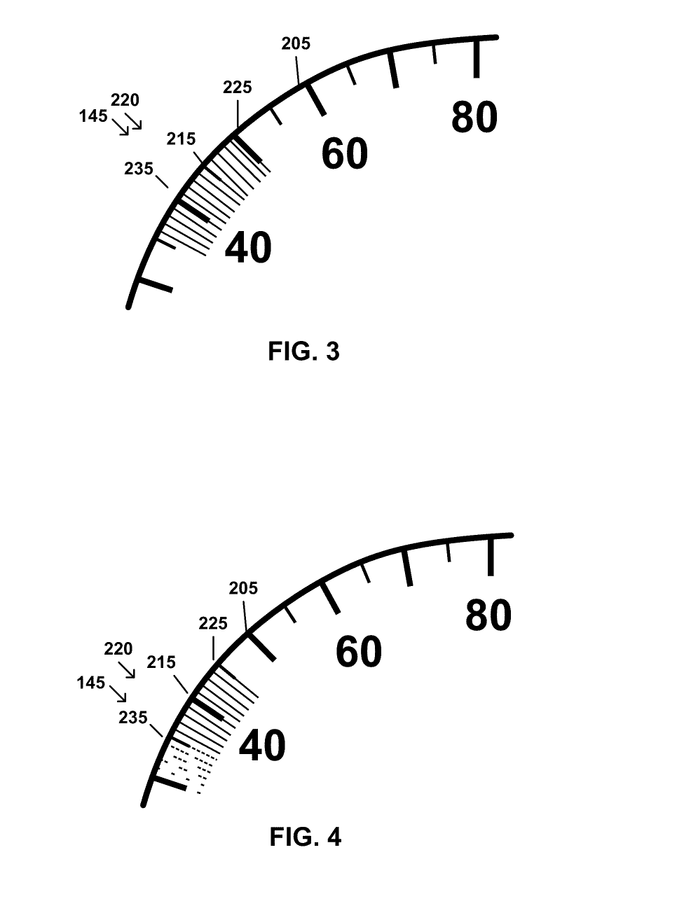

FIG. 3 illustrates a portion of a speedometer 205 and safe speed indicator 145 in which the saturation of the bars representing the range of speeds 235 equal to and less than the maximum safe speed 215 does not vary.

FIG. 4 illustrates a portion of a speedometer 205 and safe speed indicator 145 in which the saturation of the bars representing the range of speeds 235 equal to and less than the maximum safe speed 215 increases as the speed approaches the maximum safe speed 215.

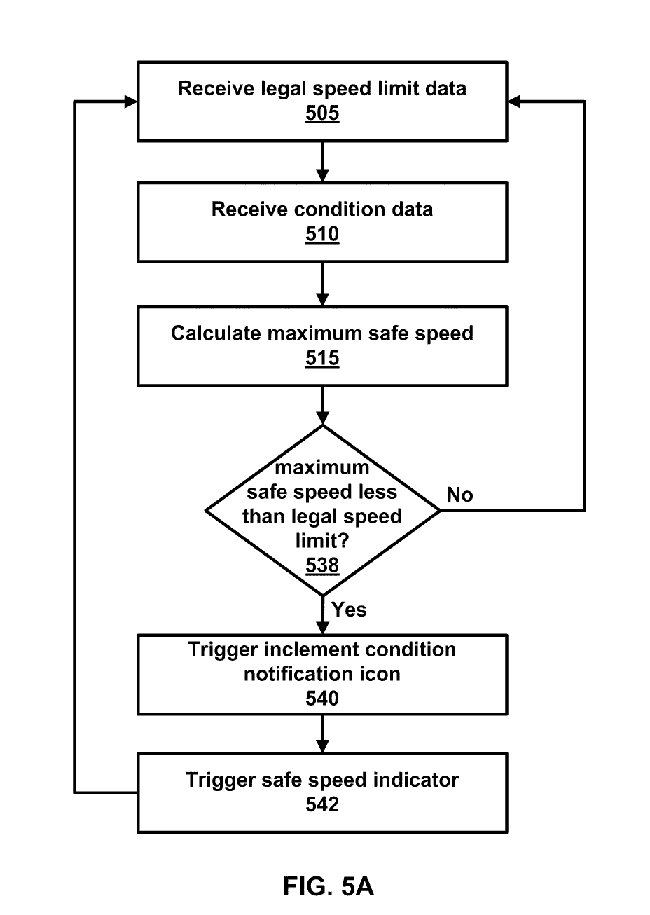

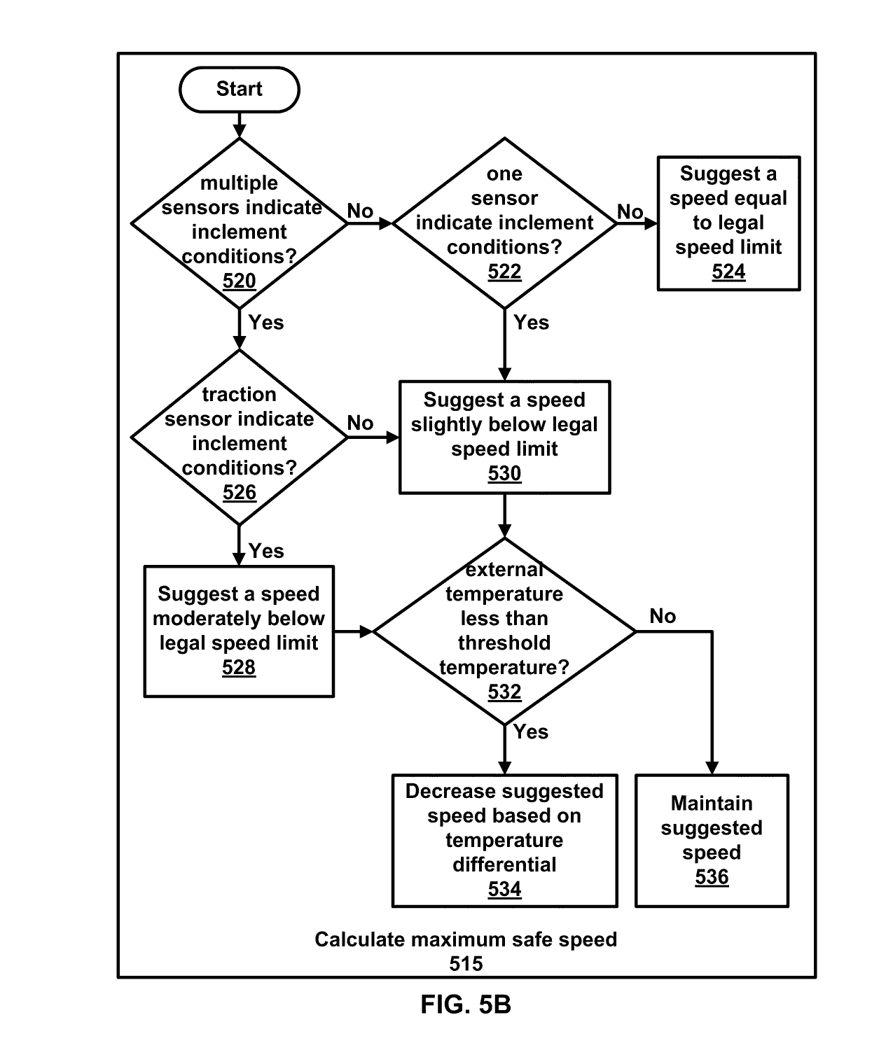

FIGS. 5A and 5B are flowcharts depicting the operation of a processor 105 embodying the features in an example embodiment of the present invention. The processor 105 may receive data concerning the legal speed limit 505 from either the GPS receiver or the pattern recognition sensor, or both. The processor 105 may also receive data concerning conditions 510 from any sensors, which can include any of the optical sensor 120, traction sensor 125, precipitation sensor 130, and temperature sensor 135. The processor 105 can then determine the maximum safe speed 515.

FIG. 5B illustrates an example process for determining the maximum safe speed 515. If it is determined at 520 and 522 that no inclement conditions are present, the processor 105 may suggest a speed equal to the legal speed limit 225 at 524. If two or more inclement conditions are present as determined at 520, and one of those inclement conditions is poor traction as determined at 526, the processor 105 may suggest a speed moderately below the legal speed limit 225 at 528. If only one inclement condition is present as determined at 522, or if two or more inclement conditions are present and none of those conditions is poor traction as determined at 520 and 526, the processor 105 may suggest a speed slightly below the legal speed limit 225 at 530. The processor 105 may determine whether the external temperature is below a threshold temperature at 532, and may determine a maximum safe speed 215 lower than the suggested speed at 534. The difference between the maximum safe speed 215 and the suggested speed at 528 or 530 may depend on the threshold temperature differential. If the external temperature is equal to or above the threshold temperature, the maximum safe speed 215 may be equal to the suggested speed 528 or 530 at 536. If the suggested speed at 524 is equal to the legal speed limit 225, the processor 105 may suggest a maximum safe speed 215 equal to the suggested speed at 524, regardless of the temperature.

Returning to FIG. 5A, if the processor 105 determines at 538 that the maximum safe speed 215 is less than the legal speed limit 525 at 528, 530, 534 or 536, the processor 105 may emit a signal at 540 to trigger the inclement condition notification icon 150 and a signal at 542 to trigger the safe speed indicator 145. If the maximum safe speed 215 is equal to the legal speed limit 225 as determined at 538, the system 100 may continue to collect data at 505.

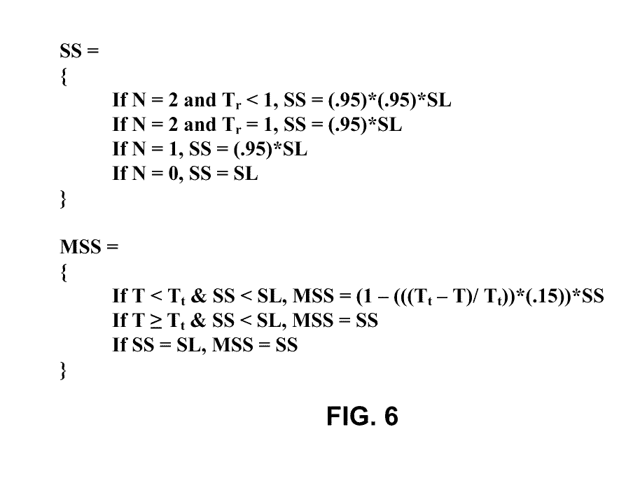

For example, an algorithm may be employed as set forth in FIG. 6, where SS is the suggested speed 524, 528 or 530; N is the number of inclement conditions present; Tr is the traction, with Tr=1 representing ideal traction, and Tr<1 representing poor traction; SL is the legal speed limit 225; MSS is the maximum safe speed 215 as determined at 524, 534 or 536; T is the external temperature; and Tt is the threshold temperature.

While this invention has been shown and described in connection with particular embodiments, it is apparent that certain changes and modifications in addition to those mentioned above may be made from the basic features of this invention. In addition, there may be many different types of computer hardware and/or computer hardware/software combinations that may be utilized for practicing the invention, and the invention is not limited to the examples described above. Accordingly, the described embodiments are to be considered in all respects only as illustrative and not restrictive, and the scope of the invention is therefore indicated by the appended claims rather than the foregoing description. All changes that come within the scope and range of the equivalency of the claims are to be embraced within their scope.

In this specification, “a” and “an” and similar phrases are to be interpreted as “at least one” and “one or more.”

Many of the elements described in the disclosed embodiments may be implemented as modules. A module is defined here as an isolatable element that performs a defined function and has a defined interface to other elements. The modules described in this disclosure may be implemented in hardware, a combination of hardware and software, firmware, wetware (i.e hardware with a biological element) or a combination thereof, all of which are behaviorally equivalent. For example, modules may be implemented as a software routine written in a computer language (such as C, C++, Fortran, Java, Basic, Matlab or the like) or a modeling/simulation program such as Simulink, Stateflow, GNU Octave, or LabVIEW MathScript. Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies are often used in combination to achieve the result of a functional module.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

In addition, it should be understood that any figures which highlight the functionality and advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A system for communicating to a motor vehicle operator the maximum safe speed at which the vehicle can be operated, the system comprising:
a. at least one receiver which detects a legal speed limit at a present location of the motor vehicle;
b. at least one sensor which detects a condition at the present location of the motor vehicle;
c. a processor configured to:
i. receive data from the at least one receiver and the at least one sensor;
ii. calculate a maximum safe speed based on data received from the at least one receiver and the at least one sensor;
iii. calculate a safe speed range based on the maximum safe speed and the legal speed limit; and
iv. transmit the maximum safe speed and safe speed range; and
d. a dashboard display configured to:
i. receive the maximum safe speed and safe speed range,
ii. alert the driver if the maximum safe speed is less than the legal speed limit, and
iii. display the safe speed range if the maximum safe speed is less than the legal speed limit.

2. A system as recited in claim 1, wherein the at least one receiver includes a Global Positioning System (“GPS”) receiver.

3. A system as recited in claim 1, wherein the at least one receiver includes a pattern recognition sensor.

4. A system as recited in claim 1, wherein the at least one sensor includes an optical sensor.

5. A system as recited in claim 1, wherein the at least one sensor includes a traction sensor.

6. A system as recited in claim 1, wherein the at least one sensor includes a precipitation sensor.

7. A system as recited in claim 1, wherein the at least one sensor includes a temperature sensor.

8. A system as recited in claim 1, wherein the at least one sensor includes a temperature sensor, a traction sensor, and at least one other sensor.

9. A non-transient tangible storage medium containing instructions that when executed by one or more processors performs a method comprising:
a. determining the legal speed limit at a present location of a motor vehicle;
b. determining the conditions at the present location of the motor vehicle;
c. determining the number of inclement conditions at the present location of the motor vehicle;
d. suggesting a speed moderately below the legal speed limit if two or more inclement conditions are present and one of the inclement conditions is poor traction;
e. suggesting a speed slightly below the legal speed limit if two or more inclement conditions are present and none of the inclement conditions are poor traction;
f. suggesting a speed slightly below the legal speed limit if one condition is present;
g. suggesting a speed equal to the legal speed limit if no inclement conditions are present;
h. decreasing the suggested speed if an external temperature is below a threshold temperature; and
i. maintaining the suggested speed if the external temperature is at or above the threshold temperature.

10. A non-transient tangible storage medium according to claim 9, wherein each of the speed suggestions are thorough a visual display.

11. A speedometer display for communicating to a motor vehicle operator the presence of inclement road conditions, the display comprising:
a. a safe speed indicator configured to be coupled with a speedometer; and
b. an inclement condition notification icon configured to be coupled with a speedometer.

12. A speedometer display as recited in claim 11, wherein the safe speed indicator and the inclement condition notification icon are activated when the maximum safe speed is less than the legal speed limit.

13. A speedometer display as recited in claim 11, wherein the inclement condition notification icon is configured and arranged to alert the motor vehicle operator to reduce his or her speed.

14. A speedometer display as recited in claim 11, wherein the inclement condition notification icon is configured and arranged to alert the motor vehicle operator of inclement conditions.

15. A speedometer display as recited in claim 11, wherein the inclement condition notification icon is configured and arranged to alert the motor vehicle operator that the maximum safe speed is less than the legal speed limit.

16. A speedometer display as recited in claim 11, wherein the safe speed indicator comprises solid bars located in the interior of the speedometer and each solid bar represents a speed within a safe speed range.

17. A speedometer display as recited in claim 16, wherein each solid bar is a shade of one of two colors.

18. A speedometer display as recited in claim 17, wherein
a. the first color is assigned to bars representing a range of speeds over the maximum safe speed; and
b. the second color is assigned to bars representing a range of speeds equal to and less than the maximum safe speed.

19. A speedometer display as recited in claim 18, wherein the saturation of the second color varies as the represented speed reaches the maximum safe speed.

20. A speedometer display as recited in claim 19, wherein the saturation of the second color increases as the represented speed reaches the maximum safe speed.
